(19) United States
(12) Patent Application Publication
(10) Pub. No.: US 2015/0178421 A1
(43) Pub. Date: Jun. 25, 2015

(54) SYSTEMS FOR AND METHODS OF MODELING, STEP-TESTING, AND ADAPTIVELY CONTROLLING IN-SITU BUILDING COMPONENTS

(71) Applicant: BrightBox Technologies, Inc., Berkeley, CA (US)

(72) Inventors: Francesco Borrelli, Kensington, CA (US); Allan Daly, Albany, CA (US); Yudong Ma, Richmond, CA (US); Bruce C. Wootton, Alameda, CA (US)

(21) Appl. No.: 14/577,644

(22) Filed: Dec. 19, 2014

Related U.S. Application Data
(60) Provisional application No. 61/919,547, filed on Dec. 20, 2013.
(60) Provisional application No. 62/022,126, filed on Jul. 8, 2014.

(51) Int. Cl. G06F 17/50; G05B 15/02; F24F 11/00

(52) U.S. Cl. CPC G06F 17/5009; F24F 11/006; G05B 15/02

(57) ABSTRACT

A system for and method of modeling thermal performance characteristics of HVAC components in a building uses the building power or other meter to measure power consumed by the components. The models are used to test the components, preferably during off hours, to ensure proper and efficient operation. Preferably, the testing software is written in a high-level interpretive language that is independent of the HVAC component being modeled. The models are adaptively maintained by periodically ensuring that their measured output matches the predicted output. When the two do not match, the model parameters are updated. These models can also be used to generate reports comparing costs and cost savings for different temperature and other environmental settings within selected zones in the building.

### RELATED APPLICATIONS

This application claims priority under 35 U.S.C. §119(e) of the co-pending U.S. provisional patent application Ser. No. 61/919,547, filed Dec. 20, 2013, and titled “System, Method and Platform for Characterizing In-Situ Building and System Component and Sub-component Performance by Using Generic Performance Data, Utility-Meter Data, and Automatic Step Testing,” and the co-pending U.S. provisional patent application Ser. No. 62/022,126, filed Jul. 8, 2014, and titled “System, Method and Platform for Automated Commissioning in Commercial Buildings,” both of which are hereby incorporated by reference in their entireties.

### FIELD OF THE INVENTION

This invention relates to controlled building environments. More particularly, this invention relates to modeling, monitoring, commissioning, and adjusting heating, ventilation, and air conditioning systems and components in buildings.

### BACKGROUND OF THE INVENTION

Environments within office and other buildings are controlled, in part, using heating, ventilation, and air conditioning (HVAC) systems. When components of these HVAC systems are installed, they must be tested to ensure that they are functioning properly. For example, they must be tested to ensure that heating systems and components and cooling systems and components bring circulating air or fluids to their correct temperatures within specific time limits, that vents open on and close on command, and that fans circulate sufficient volumes of air within closed spaces.

Typically, this testing is performed manually. HVAC equipment installers measure the environmental data (e.g., temperature, humidity, air flow, and air flow rate). The installers use power and other meters to measure these data within building zones and visually check that the vents and equipment operate according to specifications. For a medium-sized office building this testing can take weeks; for a large office building, it can take months.

When the environmental and system performance data are eventually collected, the data can be used to model the HVAC units and their sub-components, though not efficiently. Most models are configuration specific. Among other things, the models depend on the types of HVAC components, their spatial locations within the zones, and the actions for controlling these components. For example, overhead air distribution systems use a different set of actuators than under-floor air distribution systems, both of which use a different set of actuators than water-based radiators for air conditioning. Because prior art models must take all of these factors into account, the methods for generating them are time consuming, computationally difficult and intensive, and error-prone.

Furthermore, these models are static. Once generated, they are not updated to reflect operating changes in HVAC components, such as due to age, damage, or current external weather or operating load. Nor are they updated to reflect changes in building occupancy, such as when additional staff move into or are relocated within a building.

### SUMMARY OF THE INVENTION

In accordance with the principles of the invention, performance models of HVAC systems and sub-systems are modeled more efficiently and accurately. (To simplify the discussion that follows, references to “HVAC components” include HVAC systems and sub-systems.) In one embodiment, HVAC performance models are generated using power readings from the building's power meter, rather than requiring separate meters for each component in the building. These models are derived independently of the spatial locations of the components, the types of components, and the methods for controlling the components, and are thus derived faster and with fewer resources. Once these models are generated, they can be used for different purposes, such as automatic testing, to ensure that the HVAC components are working properly; adaptively updating the models; and generating reports detailing cost savings based on adjustments to the environmental conditions.

In a first aspect of the invention, a method models performance of an electro-mechanical component that controls an environment within one of multiple zones in a building. The method includes varying an input to the electro-mechanical component to generate associated outputs from the electro-mechanical component and generating a performance model of the electro-mechanical component based on the input, the associated outputs, and an energy consumption of the electro-mechanical component. In one embodiment, the energy consumption of the electro-mechanical component is determined from an energy consumption of the building while varying the input. In one embodiment, the method also includes measuring the energy consumption of the building.

Preferably, the performance model characterizes power consumed by the electro-mechanical component as a function of at least one of temperature and air flow rate. As some examples, the multiple electro-mechanical components include a fan, a chiller, a reheat valve, a packaged air-conditioning unit, or any combination thereof. In one embodiment, the output corresponds to steady-state and dynamic performance.

In one embodiment, the electro-mechanical component is one of multiple electro-mechanical components within the multiple zones in the building. The method also includes, while varying the input to the electro-mechanical component, maintaining outputs of remaining ones of the multiple electro-mechanical components at a preselected condition. In one embodiment, the preselected condition corresponds to a low-power state of the remaining ones of the electro-mechanical components, such that they draw minimal, if any, power. The energy consumption includes electrical consumption, gas consumption, or both. In one embodiment, the associated outputs correspond to air flows, air temperatures, rates of increase of air temperature, rates of increase of air flow, or any combination thereof.

In one embodiment, the performance model includes a nonlinear partial differential equation or an autoregression-moving-average model. In one embodiment, the nonlinear partial differential equation includes a Navier-Stokes equation and its linear approximation. In one embodiment, the performance model is generated from constrained least square, unconstrained least square, linear optimization, nonlinear optimization, Kalman filtering, or any combination thereof.

In one embodiment, the method also includes receiving commands from a controller for varying the inputs and restoring a prior input to the electro-mechanical component when communication between the controller and electro mechanical component is interrupted. Preferably, the method also includes using a heartbeat initiated by the controller to detect that communication between the controller and the electro-mechanical component is interrupted. In one embodiment, the controller and the electro-mechanical component are communicatively coupled over the Internet or a corporate cloud.

Preferably, the commands are in an abstraction language and include checking whether operating conditions are met before varying the inputs. As one example, the operating conditions include determining that there is pressure in a duct before varying the damper in the zone.

In one embodiment, the method also includes determining performance models for each of the multiple electro-mechanical components within corresponding ones of the multiple zones, thereby generating multiple performance models and combining the multiple performance models to generate a performance model for the building.

In one embodiment, the method includes generating a report summarizing energy savings or cost savings for any one or more of the multiple electro-mechanical components based on a set of environmental settings.

The performance model is able to be used in a variety of ways, such as for model-based control, fault detection, system design, system and component testing, automatic PID gains tuning, or any combination thereof.

In a second aspect of the invention, a method characterizes performance of a building component. The method includes choosing a set of inputs and one output for the building component; selecting a set of steady-state operation points for each input and a duration at each of the steady-state operation points; and characterizing a performance of the component based on a log of the steady-state operation, historical performance data and data sheets for the component.

In a third aspect of the invention, a method adaptively updates a performance model for a heating, ventilation, and air-conditioning (HVAC) unit. The method includes determining a model characterizing performance of an HVAC unit; automatically, periodically driving the HVAC unit with inputs and measuring associated outputs from the HVAC unit; and using the inputs and associated outputs to update the performance model. Preferably, determining the model characterizing the performance of the HVAC unit is based on historical performance data for the HVAC unit.

In one embodiment, the HVAC unit is driven with inputs using commands in an abstraction language. The abstraction language translates a source command to drive the HVAC unit from a format not supported by the HVAC unit into one or more target commands in a format that is supported by the HVAC unit.

In one embodiment, the method also includes logically inserting an agent, comprising computer-executable instructions for step-testing and controlling the HVAC unit, within normal-operating computer-executable instructions for controlling the HVAC unit. Preferably, the agent includes a heart-beat monitor, for monitoring a connection between the HVAC unit and a platform.

In a fourth aspect of the invention, a method of adaptively managing a performance model for a heating, ventilation, and air-conditioning (HVAC) component includes (a) generating a descriptive model of the HVAC component, (b) generating an abstract of data and control mapping for the HVAC component, (c) calculating parameters for the model, (d) optimizing performance for the model based on pre-determined criteria, (e) simulating the optimization, (f) applying the optimization to the model, and (g) repeating steps (a) through (f) until a measured state of the HVAC component matches an expected state of the HVAC component.

In a fifth aspect of the invention, an electro-mechanical component controls an environment within a zone in a building. The component includes a thermal element for controlling a thermal environment in the zone; a sensor for measuring a characteristic of the thermal environment in the zone; and a controller that varies an input to the mechanical component to generate a corresponding output of the thermal element within the zone and generates a performance model for the electro-mechanical component based on energy consumption of the building components, the input, and the output. The controller includes a processor and a computer-readable medium containing computer-executable instructions that when executed by the processor varies an input to the mechanical component to generate a corresponding output of the thermal element within the zone and generates a performance model for the electro-mechanical component based on the input, the output, and an energy consumption of the building. The component forms part of a fan, a chiller, a reheat valve, a packaged air-conditioning unit, or any combination thereof.

### BRIEF DESCRIPTION OF THE DRAWINGS

The figures are used merely to illustrate embodiments of the invention and are not meant to be limiting in any way. Throughout the figures, the same label refers to the same or similar element.

FIG. 1 is a high-level diagram of a system for generating performance models of building components in zones in a building, in accordance with one embodiment of the invention.

FIG. 2 is a high-level diagram of a system for generating performance models of building components in zones in multiple buildings, in accordance with one embodiment of the invention.

FIG. 3 shows a packaged unit diagram, used to illustrate performance modeling in accordance with one embodiment of the invention.

FIG. 4 shows binned slopes for modeling the package unit in FIG. 3.

FIG. 5 shows an HVAC system schematic including system components and thermal zones used to illustrate performance modeling in accordance with one embodiment of the invention.

FIG. 6 shows a functional block of a lumped state temperature, used to describe performance modeling of the thermal zone of FIG. 5.

FIG. 7 is a flow chart of a process for characterizing proper operation of a building component, in accordance with one embodiment of the invention.

FIG. 8 is a flow chart of a process for validating the correct execution of verification tests, in accordance with one embodiment of the invention.

FIG. 9 shows the components of a system 900 for adaptively managing HVAC models, in accordance with one embodiment of the invention.

FIG. 10 is a flow chart of a process 1000 for adaptively managing and using HVAC models, in accordance with one embodiment of the invention.

FIG. 11 is a flow chart of an interpreter for interpreting high-level commands for controlling HVAC components, in accordance with one embodiment of the invention. FIG. 12 shows a system for generating utility savings reports, in accordance with one embodiment of the invention.

FIG. 13 shows a report summarizing predicted cost savings for different temperature settings in zones, in accordance with one embodiment of the invention.

### DETAILED DESCRIPTION OF THE PREFERRED EMBODIMENTS

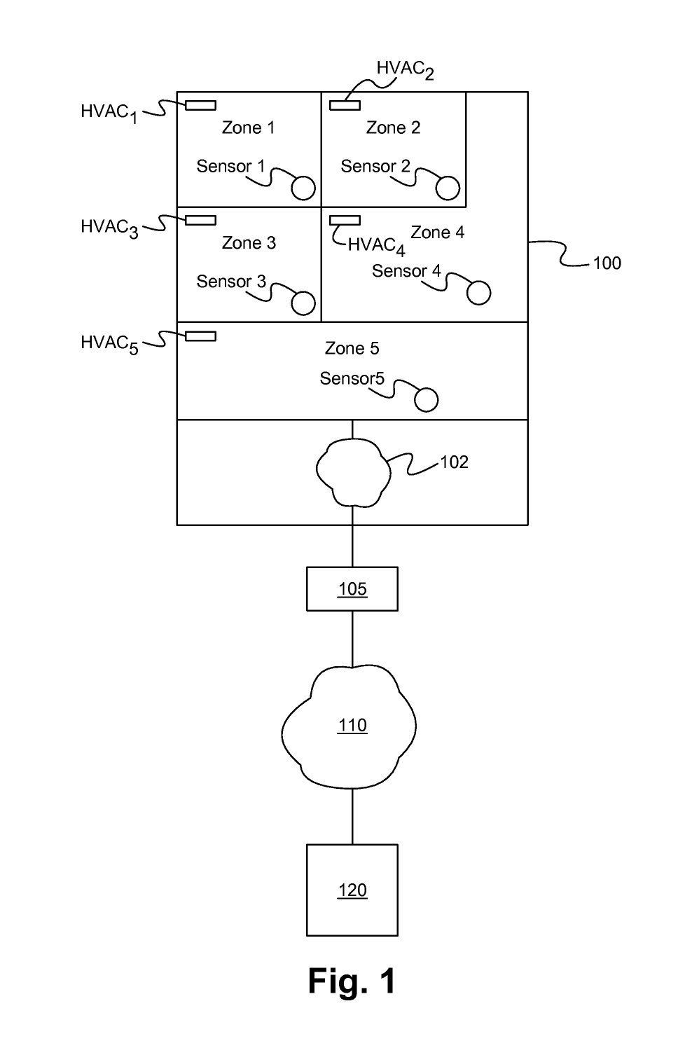

FIG. 1 shows a building 100 with multiple zones 1-5, each with its own thermal environment, and building automation system (also referred to as building management system “BMS”) 105, coupled over the Internet 110 to a control platform 120, used to model performance in the thermal environments, according to one embodiment of the invention. Each of the zones 1-5 has one or more heating, ventilation, and air-conditioning (HVAC₁₋₅) components for controlling the temperature, humidity, air flow, air flow rate, rate, or other environmental state within the corresponding zone 1-5, and a corresponding sensor 1-5 for measuring the environmental state in that zone. As discussed in more detail below, the modeling for each HVACᵢ component (i=1 to 5) is performed using a power consumption reading for a group of zones in the entire building 100, rather than a power reading taken for each HVACᵢ component. Advantageously, this modeling process does not require a power consumption meter for each of the HVACᵢ components, thereby reducing modeling costs, time, and error.

Under operation of the control platform 120, the thermal environment in a selected zone (e.g., zone 1) is driven to predetermined set points (e.g., temperature=65° F., air flow rate=10 m³/min) using a corresponding HVAC (e.g., HVAC₁), and the thermal environment is measured using the sensor in the selected zone (e.g., sensor 1). During this process, the remaining HVACs (e.g., HVAC₂₋₅) are maintained in a low-power state (e.g., an OFF state) in which they draw little power. In this way, characterization of the HVACᵢ components and the corresponding zone will reflect only the corresponding component and/or zone.

The remaining components are sequentially modeled in the same way. For example, the characteristics of the HVAC₂ component is modeled while HVAC₁ and HVAC₃₋₅ are in a low power state, etc. In a large system, sufficiently decoupled zones may be modeled in parallel.

The control platform 120 is able to characterize steady-state and dynamic responses of the HVAC components in the zones 1-5. Some examples of these characteristics include power consumed (and thus cost) as a function of thermal characteristics, temperature output into a zone as a function of air flow and temperature input into the zone, change in temperature within a zone as a function of air flow into the zone, etc. After reading this disclosure, those skilled in the art will recognize other models that can be generated and used in accordance with the principles of the invention. Furthermore, while FIG. 1 shows separate HVAC components for each zone, it will be appreciated that a single HVAC component can control environments in multiple zones.

Some examples of HVAC components include packaged air-conditioning units, chillers, fans, and re-heat valves. Zones include partitioned offices, non-partitioned spaces that have independent thermal characteristics, or any other elements of a “building fabric.”

Preferably, to inconvenience the occupants of the group of zones 100 as little as possible, the thermal environments of the zones 1-5 are modeled when the group of zones 100 is relatively unoccupied, such as at night, on the weekends, or during holidays.

While FIG. 1 shows the control platform 120 remote from the group of zones 100, in other embodiments the control platform 120 is location on or co-resident with the BMS 105. Furthermore, while FIG. 1 shows the control platform 120 coupled to a single zone group 100, it will be appreciated that the control platform 120 can be coupled to multiple buildings. In one embodiment, the control platform 120 downloads computer-executable instructions (software “agents”) to one or more buildings. The agents “hook into” HVAC control systems, which handle the normal day-to-day operations of the HVAC systems. In one embodiment, the software agents execute on the BMS 105. During the modeling process, for selected HVAC components in each zone, the agents drive the HVAC component in a pre-determined manner, measure resulting environmental data, and then transmit this environmental data to the control system 120. In one embodiment, the control system 120 uses this data, component data gathered from data sheets, historical performance data for the entire building, and log operational data to generates a performance model for the component.

As explained above, the BMS 105 exchanges data and commands with components in the building 101. In some embodiments, functionally, the interface between the two appears as a cloud network, shown schematically as cloud network 102.

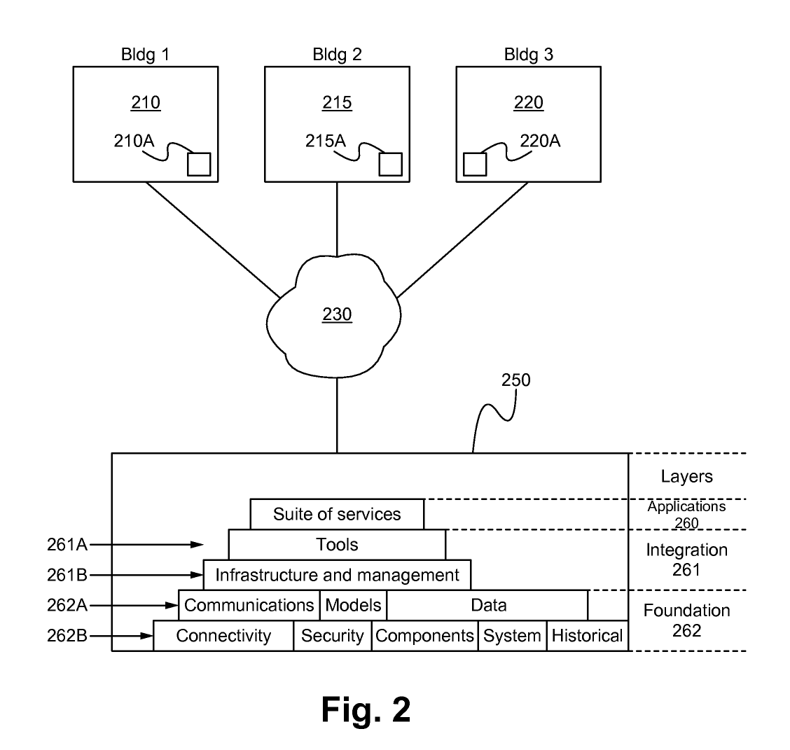

FIG. 2 is a high-level diagram of an environment 200 for modeling performance characteristics of HVAC components contained in zones in buildings 210, 215, and 220. Each of the buildings 210, 215, 220 has a corresponding software agent 210A, 215A, 220A, coupled to the control platform 250 over the Internet or corporate cloud 220. The control platform 250 has similar components and functionality as the control platform 120. Each of the agents 210A, 215A, and 220A exercises the HVAC components in the buildings 210, 215, and 220, respectively, gathering thermal data, and transmits the thermal data to the control system 220 for modeling, as described above.

The control platform 250 includes several functional layers 260-264. The application layer 260 includes a suite of services. The integration layer 261 includes a tools sub-layer 261A and an infrastructure and management sub-layer 261 B. The foundation layer 262 includes a first sub-layer 262A and a second sub-layer 262B. The first sub-layer 262A includes communications, models, and data, and the second sub-layer 262B includes connectivity, security, components, system, and historical data.

The tools sub-layer 261A includes a usage-report generator, summarizing power consumption for different environment settings, such as described below. The sub-layer 262A includes performance models, such as described herein, data, including current environmental data recently received from the agents 210A, 215A, and 220A, and historical data, including environmental data and entire building data, previously received from the agents 201A, 215A, and 220A.

While FIG. 2 shows the control platform 250 coupled to three buildings 210, 215, and 220, it will be appreciated that the control platform 250 is able to be coupled to, and thus control and communicate with agents, on any number of buildings.

### Examples of Models Characterizing In-Situ Building Components

Performance models generated in accordance with the principles of the invention include steady-state and dynamic performance models, which are generated without requiring additional sensors. HVAC components modeled in accordance with embodiments of the invention include packaged air-conditioning units, chillers, fans, re-heat valves, thermal spaces, and thermal zones. The component behavior characteristics include the response time of the heating sub-system controller by a zone re-heat valve. In one embodiment, these characteristics are generated using only a temperature sensor in the zone and the power meter for the entire building, though in other embodiments, additional sensors or power meters can be used. Steady-state performance includes characteristics, such as thermal resistance, thermal capacitance, and component efficiency. Dynamic performance can be determined for characteristics such as output as a function of the temperature of air entering a zone, the temperature of air leaving a zone, and ambient air temperature in the zone.

The component performance models derived from the methods can be used in a number of model-based technologies, such as model-based control, fault-detection, model-based system design, and automatic PID gains tuning, just to name a few examples.

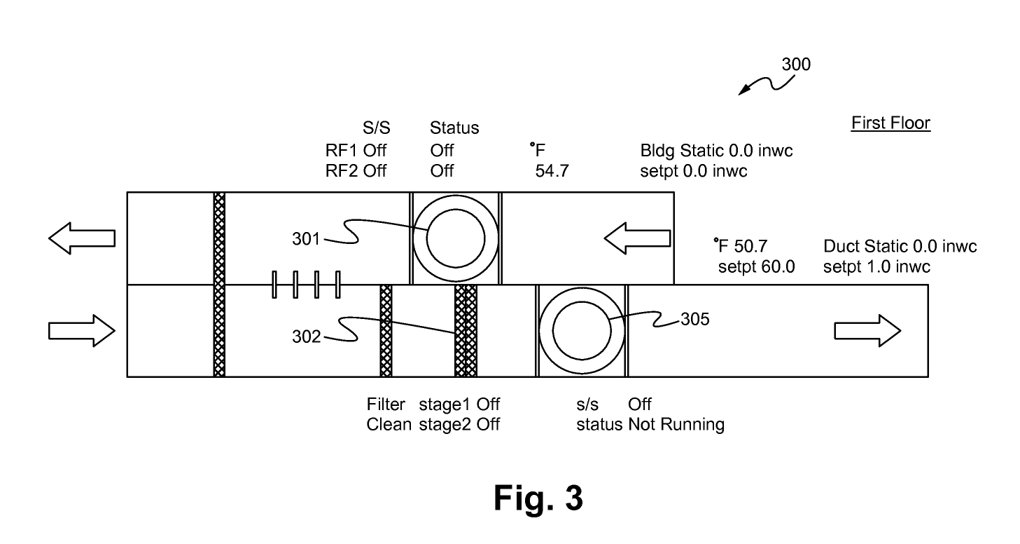

FIGS. 3-6 show illustrative HVAC components, functional block diagrams, and other information for generating performance models in accordance with the principles of the invention. FIG. 3 shows a diagram of a packaged unit 300, which includes two compressors (301 and 302) and one fan 305. As one example, the performance model for power consumed by the packaged unit 300 is given by equation (1):

Pwr=f_{pu, k}(flowₜₒₜₐₗ, T_{S}, T_{mixed}) (1)

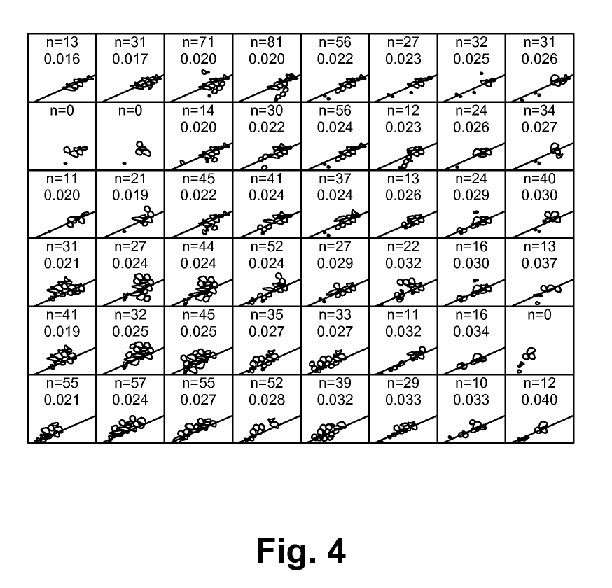

In this example, the sub-components of the packaged unit 300 are also modeled. When modeling some components, certain “constraints” or “prerequisites” must be met for accurate modeling. As one example, to prevent a heater from overheating, the heater will not be turned ON until an associated fan is turned ON. Other constraints are based on the limitations of mathematical modeling. In this example, constraints for the fan 310 model include (1) power is required only when the fan is ON, and (2) the model fits the nth order polynomial: Pwr_{fan}=poly(mₜₒₜ). Constraints for the compressor (301 and 302) model include (1) maximum power is required for each compressor and each compressor's status signal, (2) the compressor's power is estimated by fitting the scheduled polynomial models: Pwr_{comp}=slope*max(T_{S}−T_{mixed}), and slope=poly(T_{mixed, m}ₜₒₜ), and (3) the poly( ) function is required to fit bin slopes as a function of inputs (T_{S} and T_{mixed}) in given input ranges. FIG. 4 shows a portion of the binned slopes for this example.

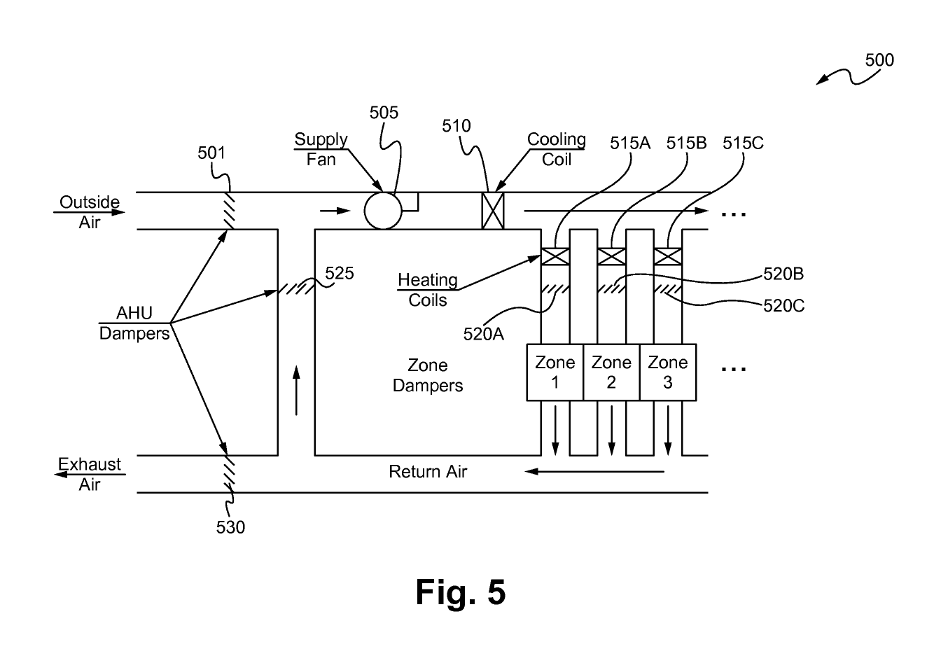

FIG. 5 is a diagram 500 of a packaged unit and thermal zones and zone components for multiple zones 1-3. As shown in FIG. 5, outside air flows through a first air-handling unit (AHU) damper 501, to a supply fan 505, past a cooling coil 510, through heating coils 515A-C and their associated zone dampers 520A-C, and into zones 1-3. The return air flows both through a second AHU damper 525 back to the supply fan 505, and also through a second AHU damper 530, where it is exhausted from the packaged unit 500. The temperature performance model for the packaged unit 500 is given by equation (2):

T_{zi}=f_{zone}((flowᵢ, Tₛᵢ) (2)

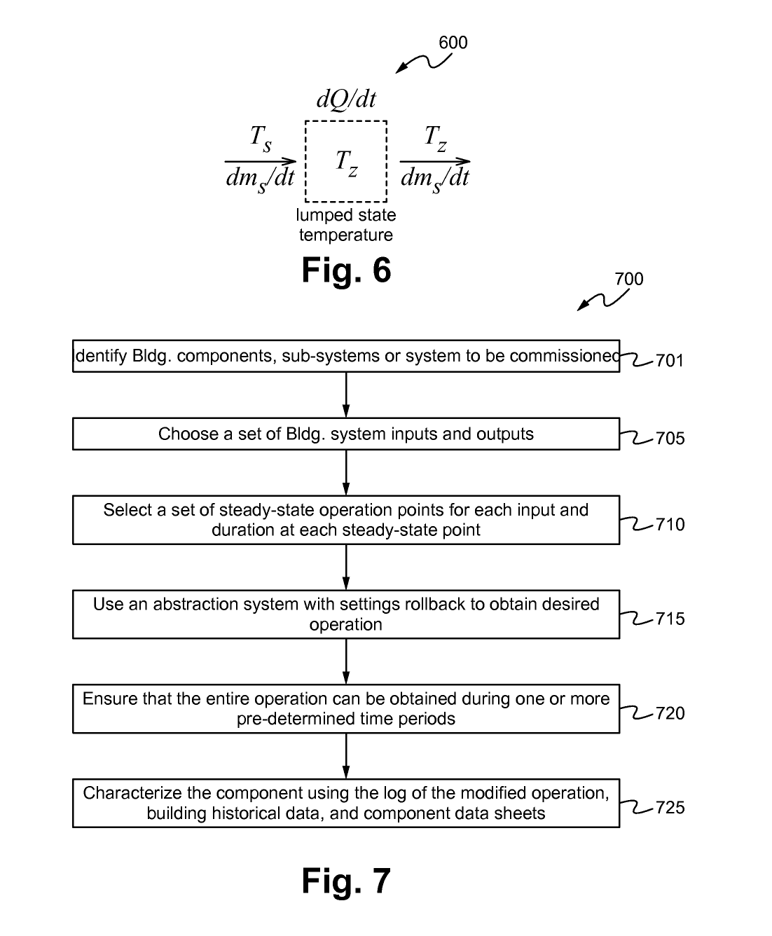

FIG. 6 is used to illustrate how a performance model is derived for a thermal zone.

FIG. 6 shows a functional block diagram 600 of a thermal zone, showing inputs Ts, dTₛ/dt, and dQ/dt, and outputs T_{z} and dMₛ/dt. The lumped state temperature of the thermal zone is derived using a simple energy balance equation (3):

(m)dT_{z}/dt=dQ/dt+cₚ(dmₛ/dt)(Ts−Tz) (3)

The equation is derived from two coupled states, Tₘₐₛₛ and T_{zone}, derived from equations (4) and (5):

adT_{z}/dt=dQ/dt+b(dmₛ/dt)(Tₛ−T_{z})+γ(Tₘₐₛₛ−T_{z}) (4)

Tₘₐₛₛ=c+kT_{amb}(t−δ) (5)

Parameter identifiers (PIDs), for both historical and real-time data, can also be modeled in accordance with the principles of the invention. For a PID, the Tₘₐₛₛ parameters are given by equation (6):

Tₘₐₛₛ=c+kT_{amb}(t−δ) (6)

In this example, during a period of no airflow and no transients, Tₘₐₛₛ=T_{zone}. The term δ is estimated from the time between peaks in T_{amb} and T_{zone}. The terms c and k are estimated from least squares. The term k is classified as a function of T_{amb max}−T_{amb min} over 24 hours. In this example, higher order dynamic models (linear and nonlinear optimal experimental design (OED)) are also tested. The T_{z} parameter is determined from equation (7):

mKcₚdTz/dt=dQ/dt+b(dmₛ/dt)(Tₛ−T)+γ(Tₘₐₛₛ−T_{z}) (7)

where cₚ is the heat capacity of air, determined from equations (8) and (9):

(mc)dT_{z}/dt=dQ/dt+cₚ(dmₛ/dt)(Tₛ−T_{z}) (8)

m=rho*volume (9)

where, for example, the height of a zone=9 feet. The terms m and b are the zone size. The term y is the time constant to reach Tₘₐₛₛ. The term γ is estimated when the system turns OFF (e.g., at the end of the day), from the time it reaches T_{z}_{_{—}}₀+0.95(T_{z}_{_{—}}ₘₐₓ−T_{z}_{_{—}}₀)), where T_{z}_{_{—}}₀ is the zone temperature when the system goes OFF, and T_{z}_{_{—}}ₘₐₓ is the maximum zone temperature over the following 6 hours. The term K is estimated from the morning temperature slope. The term dQ/dt is the load, as the difference between T_{Z} predicted according to the model and the T that was actually measured, classified as a function of T_{amb}.

The real-time PID is characterized using equations (10) and (11):

Tₘₐₛₛ=c+kT_{amb}(t−δ) (10)

(a)dT_{z}/dt=dQ/dt+b(dmₛ/dt)(Tₛ−T_{z})+γ(Tₘₐₛₛ−T_{z}) (11)

Preferably, these equations are re-estimated every day, dQ/dt is forecast, and are re-scheduled and re-learned. Preferably, higher-order linear and nonlinear OED are also tested.

These examples of modeling components is merely illustrative. After reading this disclosure, those skilled in the art will recognize other modeling methods and associated equations and other components that can be modeled in accordance with the principles of the invention.

### Auto-Commissioning

In accordance with one embodiment of the invention, performance models are used to perform automated “commissioning” of commercial buildings. During these step-tests, HVAC components are driven with pre-determined signals and the outputs are measured to ensure that the components are operating properly, as intended by the building designers, engineers, or contractors. Because this commissioning is performed automatically and can be triggered remotely, it can be performed on short notice, for reduced costs, and with increase accuracy. In one embodiment, auto-commissioning uses a platform, such as described above (e.g., 120 or 250).

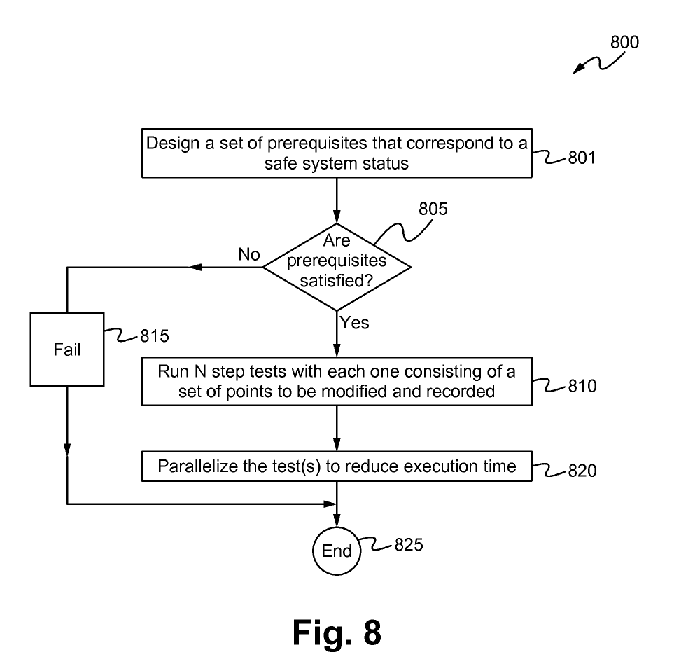

FIG. 7 shows the steps of an automated commissioning process 700, in accordance with one embodiment of the invention. In the step 701, building components, sub-systems, or systems to be commissioned are identified. Next, in the step 705, a set of building system inputs and outputs are selected. As one example, for a single component, a set of inputs and one output is selected. For a packaged unit containing one fan and two compressors, for example, input₁ is fan speed, input₂ is to the first compressor, input₃ is to the second compressor, and the output is the energy consumption for the packaged unit. Next, in the step 710, a set of steady-state operation points for each input and the duration at each steady-state point are selected. For example, the steady-state points include the minimum, maximum, and average fan speeds. For each signal, the data sampling rate is separately chosen.

Next, in the step 715, an abstraction system, with settings rollback, is used to obtain the desired operation. As explained in more detail below, the settings rollback are values that the inputs are returned to in case of a communication error during the auto-commissioning. The values are also used to return the system to its normal operating configuration. The abstraction system is able to solve an optimization problem to generate the steady-state request. As one example, if it is desired that the fan in this example, but neither compressor, is to be turned ON, the T_supply set point must be specified to ensure that the compressors do not turn ON. As another example, a command cannot be given to start the fan at minimum flow since, generally, no such command exists. Instead, to turn ON the fan, the abstraction layer is able to set the fan at minimum total flow. The abstraction layer will then determine that, to generate this output, all the zones must be to set to minimum flow. As also explained below, the abstraction layer thus translates the original “source” command to a “target” command to turn he flow in all the zones to minimum flow.

After the step 715, in the step 720, it is ensured that the entire operation can be obtained during one or more pre-determined time periods, such as late at night when the building is unoccupied, on weekends, or during holidays. These time periods can be automatically learned from the data, or provided as input, such as from the building manager, an automated schedule, or the commissioning agent.

After the step 720, in the step 725, the components are characterized using, for example, the log of the modified operations, the building's historical data, and component data sheets. In the step 725, the component performance characterization includes choosing a model and a technique to characterize the model. Examples of these models include differential equations, auto-regression-moving-average mode (ARMAX). Examples of techniques include constrained and unconstrained least square, linear and non-linear optimization, and Kalman filtering. The technique uses building historical data to remove measured effects, which do not depend on the modified operation. This includes, for example, instance power meter, packaged unit consumption, and lighting consumption, as just a few examples. The component data sheets are used as an initial-guess for the identification technique.

Together, the performance models of the HVAC components are able to be combined to characterize an interconnected system of building components.

In one embodiment, the functional description of components, whether user driven or data driven, is developed using a graphical user interface (GUI). Using the methods described above, constraints on system operation (e.g., minimum and maximum values) are established. These functional descriptions, with the constraints, with generic models (e.g., empty or populated with default data) are used to automatically generate step-test procedures to isolate components to determine both static and dynamic performance characteristics. In this way, these performance models are able to used for advanced system control.

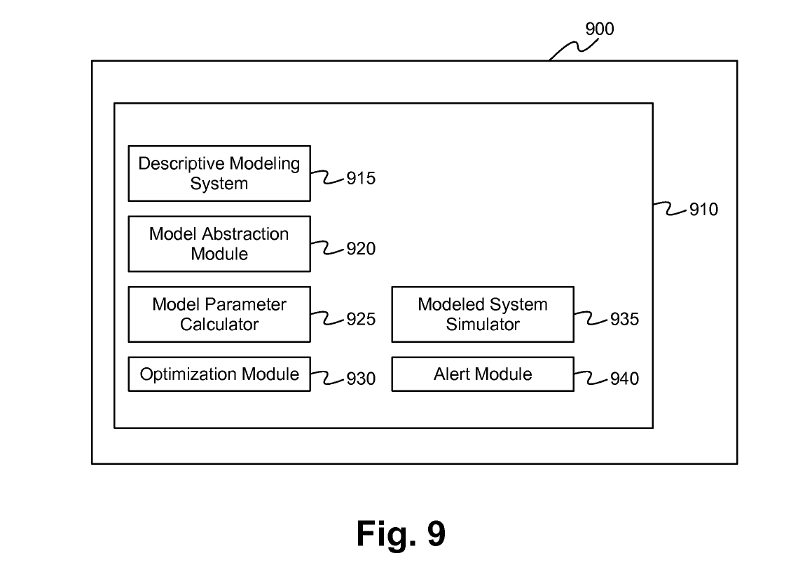

FIG. 8 shows the steps of a real-time process for validating the correct execution of each step test. In one embodiment, the process is executed by a platform, such as element 120 or 250, in FIGS. 1 and 2. In an initialization step 801, a set of prerequisites, corresponding to a safe system status, is designed. As one example, when an air-conditioning unit is ON, the static pressure must be within specified bounds. In the step 805, it is determined whether specified prerequisites are satisfied. If the prerequisites are satisfied, in the step 810, N step tests are run, with each step test consisting of a set of points to be modified and recorded. A subset will be recorded at higher speed and will be used to verify the success of the test. If, in the step 805, it is determined that the prerequisites are not satisfied, a FAIL state is entered in the step 815, and the process proceeds to the step 825, where it ends. In the step 815, feedback, such as a system failure alert, is provided to a user or the system, and the system waits for an appropriate response, and either executes new tests or re-schedules the step test. After the step 810, the tests are parallelized to reduce execution time and, after the tests have completed, the process continues to the step 825, where it ends.

In one embodiment, the feedback in the step 815 is provided to automated commission users. Some examples of user feedback include information about the malfunctioning building components and actionable information on how to resolve the malfunction. The new tests that are optionally executed in the step 815 use one or more of the log of the step-test operations, building historical data, component data sheets, and component models.

As one example, a building model auto-commissioned using the process 800 is used to access thermal coupling and the time to reach steady-state. This information is then used to decide which thermal zones to step test in parallel and for how long, with the goal of reducing total testing time while minimizing coupling effects.

In one embodiment, a platform includes one or more processors and computer-readable media storing computer-executable instructions that when executed by the processor perform the steps 700 and 800. It will be appreciated that the platform can be a single platform or a distributed one.

It will also be appreciated that the steps 700 and 800 are merely illustrative of one embodiment of the invention. After reading this disclosure, those skilled in the art will recognize other modifications in accordance with the principles of the invention. For example, in other embodiments, some of the steps 700 and 800 are deleted, other steps are added, and some steps are performed in different orders.

### Virtual Power Meter

In accordance with the principles of the invention, performance models for multiple HVAC components are generated by using power measured using a single power meter (e.g., electrical, gas, or a combination of both) for the entire building. In accordance with different embodiments, utility data are used to identify the time frame with minimum based load variation (e.g., when no one is in the building). As one example, step tests are performed on a fan during the time frame (active fan, inactive fan). For each period of inactivity, the base load is estimated. The estimated base load is then used to detrend the power meter reading. This data is then used for fitting the polynomial models.

### Adaptive Management of HVAC Models

In accordance with the principles of the invention, HVAC models are able to be managed and adaptively controlled. An HVAC optimization system in accordance with one embodiment of the invention continuously gathers data about the operation of the underlying system and compares real system behavior with expected behavior based on model simulations and heuristics. This allows the system to alert an operator when physical faults in the system or condition changes in the system invalidate the current optimization model. The adaptive system can then be remodeled and re-optimized according to the new conditions present in the underlying system.

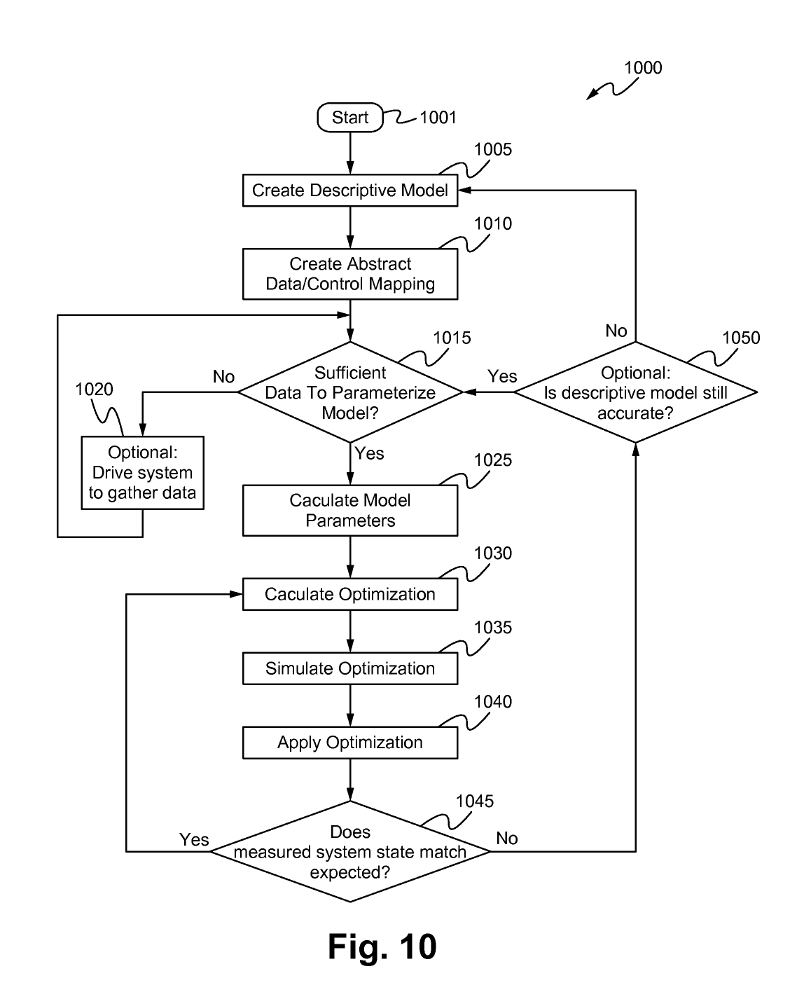

FIG. 9 shows a control platform 900 that includes an HVAC optimization system 910, in accordance with one embodiment of the invention. The HVAC optimization system 910 includes a descriptive modeling system 915, a model abstraction module 920, a model parameter calculator 925, an optimization module 930, a modeled system simulator 935, and an alert module 940.

The model abstraction module 920 receives as input measurements and controls of the modeled system and maps the data and control signals to points in the descriptive model. The model stores enough data to parameterize the model. The model abstraction module 920 also partitions the data by explicit or implicit changes in the set of conditions of the system being measured. These changes can result from system wear, new parameters for local control of the system, or replacement of the lower-level control programs or equipment. As some examples, partitioning criteria include the time of day, the time of year, occupied status of the serviced space, and particular uses of the serviced space. The model abstraction module 920 is able to apply and roll back settings to the underlying control system.

The model and abstraction module 920 is also able to map a series of settings to an abstract setting. For example, when the optimization engine wishes to set an airflow in the underlying system, but the underlying system doesn't offer access to the airflow control, the model is able to manipulate other settings, such as damper position or set point temperature to accomplish the desired action in the underlying system. One example would be to limit the electrical power use of the system.

The model parameter calculator 925 calculates model parameters using statistical analysis of collected data from each relevant partition of conditions. The optimization module 930 optimizes the condition of the system against a desired set of criteria or exercises the system in some way. As some examples, the criteria include a combination of minimized energy usage, minimized utility costs, and acceptable environmental conditions within the served building. The outputs of the optimization module 930 are periodic and control adjustments to the underlying control system. In one embodiment, the optimization module 930 runs once a minute and the model parameters are recalculated one a week.

The modeled system simulator 935 evaluates the model with a calculated set of parameters. The output of the modeled system simulator 935 is compared to the actual performance of the system and variants. The modeled system simulator 935 is able to run on the underlying system or on a separate system.

The alert module 940 alters operators and remodels, or re-optimizes, the underlying system when the results of the simulation diverge by a pre-determined amount from expected results. In some cases, the descriptive model is able to be changed, such as when new equipment is added to the underlying system or when low-level executable software is added to the underlying system.

In different embodiments, the optimization performed by the optimization system 910 occurs either in the control system itself or in an overlay control system that uses the original control system for measurement and parameter adjustment. In the case of an overlay control system, some or a majority of control decisions for HVAC equipment can remain in the controllers of that equipment, with the optimization system adjusting the parameters of the local control systems.

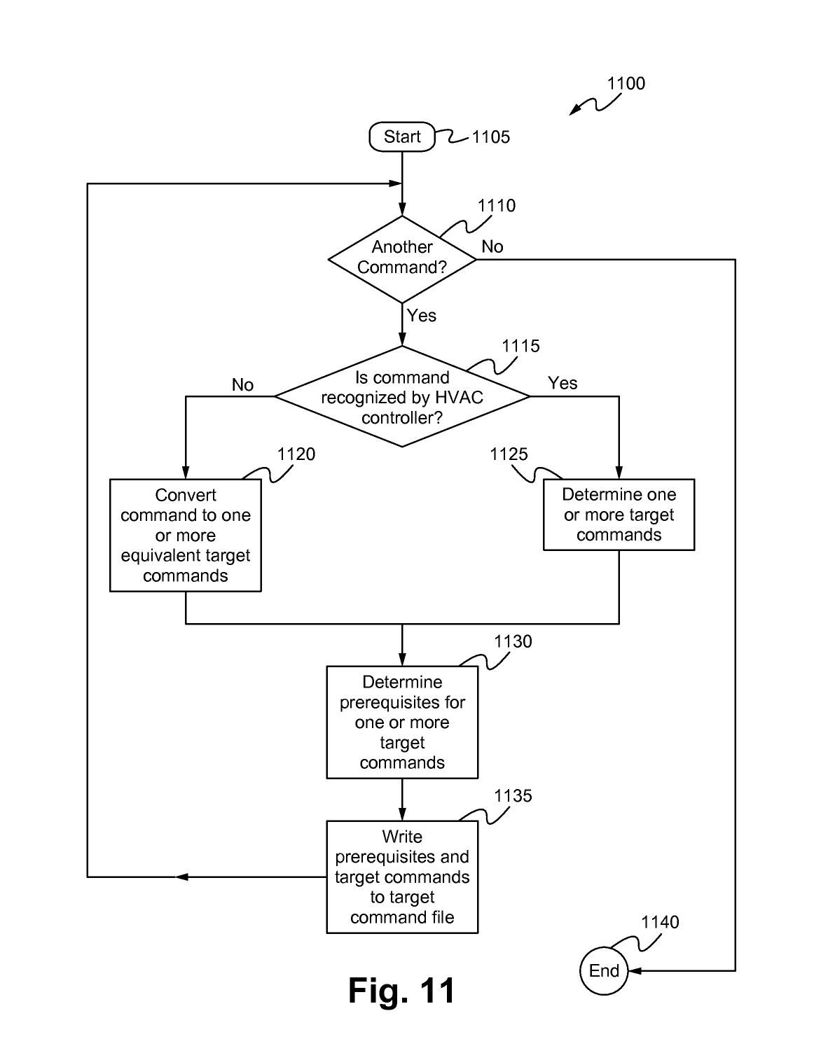

FIG. 10 shows the steps of a process 1000 for adaptively managing an HVAC model using the HVAC optimization system 910 in accordance with one embodiment of the invention. After the start step 1001, in the step 1005 the descriptive modeling system 915 creates (e.g., generates) a descriptive model of the HVAC component. Next, in the step 1010, the model abstraction module 920 creates an abstract data/control mapping of the model. Next, in the step 1015, it is determined whether sufficient data exists to parameterize the model. If sufficient data does not exist, in the optional step 1020, the system is driven to gather data and the step 1015 is performed again. If sufficient data does exist, in the step 1025, the model parameter calculator 925 calculates model parameters, in the step 1030, the optimization module 930 calculates optimized parameters, in the step 1035, the model system simulator 935 simulates the optimization, and in the step 1040, the optimization is applied to the model. From the step 1040, in the step 1045, it is determined whether the measured system matches the expected system. If the two match, the step 1030 is performed again; otherwise, the optional step 1050 is performed. In the step 1050, it is determined whether the descriptive model is still accurate. If it is, the step 1015 is performed again; otherwise the step 1005 is performed.

In one embodiment, a platform includes one or more processors and computer-readable media storing computer-executable instructions that when executed by the processor perform the steps 1000. It will be appreciated that the platform can be a single platform or a distributed one.

It will also be appreciated that the steps 1000 are merely illustrative of one embodiment of the invention. After reading this disclosure, those skilled in the art will recognize other modifications in accordance with the principles of the invention. For example, in other embodiments, some of the steps 1000 are deleted, other steps are added, and some steps are performed in different orders.

### Abstraction Layer

As described above, some embodiments of the invention include an abstraction layer that, among other things, (1) translates generic commands for controlling HVAC components into commands understandable by the systems that control the HVAC components and (2) ensures that any prerequisites are met before the components are adjusted based on the commands.

As one example, a high-level code fragment is written to loop through multiple packages, and for each component in a package actually connected to the system, if the measured air flow rate is above a CONSTANT value, particular commands are performed:

```
for package_unit in package_unit.objects.all( )
    for var_component in package_unit.connected_system
        if (var_box.upstream_AirInput.T.path.get_latest{ }.value >=
        CONSTANT)
            [SET VALUES OF AIRFLOW RATE]
            [ADJUST COMPONENT INPUT]
```

In this example, these particular commands (SET VALUES and ADJUST COMPONENT INPUT) are to be performed by the components. These generic, high-level commands are translated into specific commands recognizable by a controller and executable by the component. Moreover, these commands are only executed when certain prerequisites are satisfied.

As one example, when turning ON a fan during step testing, the abstract layer must first determine the prerequisite: an “occupancy” variable must be set to OCCUPIED, since during normal operations the fan controller will only turn ON the fan when a zone is occupied and the temperature variable is set to the desired setting. Rather than using a separate “FAN ON” command, which the controller does not recognize, the abstract layer indirectly turns the fan ON by setting the occupancy flag ON and setting the temperature variable to the desired setting. In other words, in this example, the abstraction layer translates the “source” command “TURN ON FAN” to the “target” commands:

SET OCCUPANCY ON

SET TEMPERATURE 20

Generally, the target commands are low-level commands specific to the HVAC component being controlled and are thus in a format different from that of the high-level source commands.

As another example, when a high-level command is to increase the air flow to a zone, such as an office, the abstraction layer inserts the prerequisite of testing whether the dampers are open before starting a fan, thereby ensuring that the increase in air pressure does not damage ducts. In this example, the abstraction layer translates the source command AIRFLOW=100 to the target commands:

READ DAMPER_STATUS

IF DAMPER_STATUS CLOSED THEN SET DAMPER_STATUS OPEN

SET AIR FLOW 100

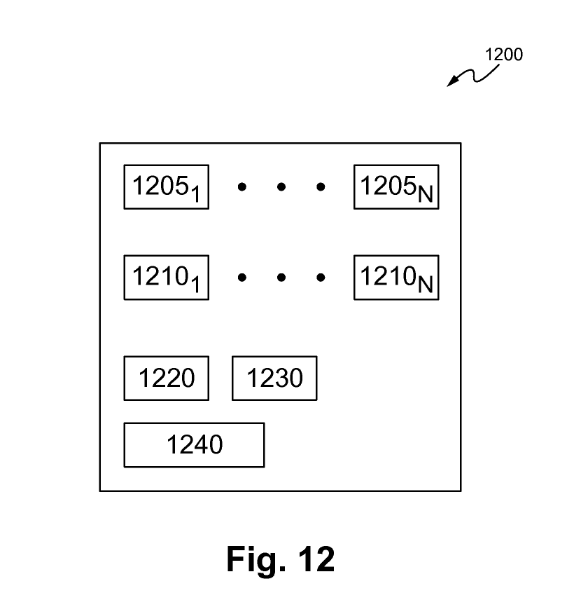

FIG. 11 is a flow chart showing the steps 1100 of a process for translating interpretive high-level commands into commands for driving HVAC components, in accordance with one embodiment of the invention. The final “target” file forms part of the agent software downloaded to the HVAC controller for controlling an HVAC component.

Referring to FIG. 11, in the start step 1105 data are initialized and a target command file, for driving the HVAC component, is created. In the step 110, the abstraction layer parses the list of commands (source commands) and determines whether a “next” source command is ready to process. If there is no next command (e.g., if the file is empty or the last command has been processed), in the step 1115, it is determined whether the command can be directly translated into one or more target commands recognizable by the HVAC component. If the command is not directly translatable into one or more target commands, the command is translated into the one or more equivalent target commands. If the command is directly translatable into the one or more target commands, the target commands are determined in the step 1125. Both of the steps 1120 and 1125 proceed to the step 1130, where any prerequisites for executing the target commands are determined. From the step 1130, in the step 1135, the prerequisites and the target commands are written to the target command file. From the step 1135, step 1110 is entered. If, in the step 110, it is determined that there are no more commands to execute, the step 1140 is entered, where the process ends. The target command file forms part of the agent software (e.g., executable file) downloaded to the HVAC component.

In one embodiment, a platform includes one or more processors and computer-readable media storing computer-executable instructions that when executed by the processor perform the steps 1100. It will be appreciated that the platform can be a single platform or a distributed one.

It will also be appreciated that the steps 1100 are merely illustrative of one embodiment of the invention. After reading this disclosure, those skilled in the art will recognize other modifications consistent with the principles of the invention. For example, in other embodiments, some of the steps 1100 are deleted, other steps are added, and some steps are performed in different orders.

Using the abstraction layer in accordance with the invention, programmers are able to write portable programs that drive and test HVAC components, without knowing the details (e.g., prerequisites) of these components.

### Software Agents and Heartbeat Monitors

Embodiments of the invention include many computationally intensive functions, such as determining performance characteristics of the HVAC components, performing auto-commissioning, translating source commands into the target commands for driving the HVAC components using an abstraction layer, adaptively managing HVAC components, and generating reports summarizing utility savings, to name only a few such functions. In some embodiments, these functions are performed on the HVAC components. In other embodiments, because these components do not have the processing capabilities to perform these functions at all or efficiently, these functions are performed on a remote platform. In these other embodiments, software agents are downloaded to the buildings to control the HVAC components. The agents drive HVAC components in pre-determined manners and transmit data to the remote platform for processing.

In operation, the software agents are automatically injected into the program of the lower-level controller for the HVAC components. An automated program searches for patterns indicating control points in the lower-level controller code and injects a fragment of new code that implements both a hook and a “heartbeat” into the code. The hook allows a supervisory system to override the values of the control points in the lower level controller. In HVAC systems, the hook can be visible through the BACNET protocol. Preferably, the hook has some method of storing the original overridden value. In one embodiment, the heartbeat is a monotonically increasing value that is also received from the supervisory system. If the heartbeat does not increase within a set period of time, the hook must override heartbeat with the original overridden value. In BACNET, the new value can be set to a higher priority than the existing value. If the heartbeat fails to trigger, the lower priority value will be restored and the state of the HVAC component is “rolled back” to its previous state.

As one example, a heating component on a packaging unit is tested during an auto-commissioning test or during adaptive management of an HVAC model. The heating component is set at 65° F. before the agent begins the auto-commissioning process. When the agent begins the auto-commissioning process, such as at night, it first saves the current temperature setting (the overridden value) and begins the heartbeat monitor. The agent then initializes the temperature to 90° F., increasing it to particular set points during the auto-commissioning process, and transmits measured data to a remote platform. If, during auto-commissioning, the agent determines that communication between it and the remote platform has terminated, the agent resets (rolls back) the temperature of the heating component to its overridden value (65° F.), stops the auto-commissioning process, and returns control of the thermal component to its normal operating code. In this way, the terminated communication between the agent and the remote platform does not leave the building in an unexpected state.

### Summarizing Utility Savings Based on Adjustments to Environmental Condition Constraints

In accordance with embodiments of the invention, reports that allow users to determine utility savings by adjusting environmental condition constraints can be generated. From a report, for example, a user may see that lowering the temperature in a particular zone by 1° F. for one hour during lunchtime, when the zone is lightly unoccupied, will result in a energy savings of about $150 each month, and lowering the temperature by 2° F., will result in savings of about $200 each month. The user can then balance cost versus comfort to determine an energy plan.

In operation, a centralized platform incorporates Building Management Systems (BMSs), weather station, utility price data, both historical and real time, to create predictive models of the utility costs attributable to individual components of the HVAC system. This allows for numerical optimization of the whole building utility cost using environmental zone conditions as constraints. The optimization process identifies the financial cost to meet the load in each zone and the effect of relaxing the environmental condition constraints. This granular information can be presented to the user to make informed decisions when changing zone set points. The system automatically writes the most optimal settings to the BMS periodically, such as every 5 minutes, though other time periods can also be used.

FIG. 12 shows a system 1200 for generating utility savings reports, in accordance with one embodiment of the invention, for a building that includes N major energy-consuming HVAC components, for any integer N. The system includes, for each of the major energy-consuming HVAC components HVACᵢ, an associated energy-consumption calculation module 1205ᵢ and an associated load-predictor module 1210ᵢ, for i=1 to N. The system 1200 also includes a financial-cost calculator 1220, a system optimizer 1230, and a graphical user interface (GUI) 1240. Each energy-consumption calculation module 1205ᵢ calculates the energy consumption of its corresponding HVACᵢ as a function of load. Each of the load-predictor modules 1210ᵢ predicts a load for its corresponding HVACᵢ. The load prediction is generated with first-principle thermodynamic models trained on historical building data.

The financial-cost calculator 1220 calculates the financial cost of a quantity of energy consumed at a given time based on the utility rate tariff schedule of the facility. The system optimizer 1230 optimizes the operation of the system for minimized utility costs within environmental condition constraints set by the user. The output of the model is periodic control adjustments to the underlying control system. The GUI 1240 displays to the user quantitative data predicting the effect of a range of changes to the environmental condition constraints.

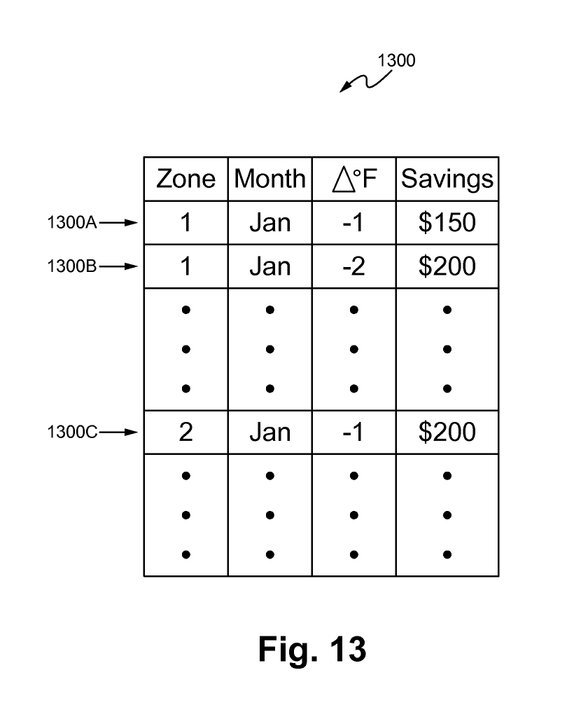

FIG. 13 shows a report 1300 (such as displayed on the GUI 1240) summarizing cost savings in accordance with one embodiment of the invention. The report displays for each zone, time of year, and temperature change, a predicted cost savings. For example, the entry in row 1300A shows that reducing the temperature in zone 1 during the month of January by 1° F. will reduce heating costs for the month by $150. The entry in row 1300B, shows that reducing that temperature by 2° F. will reduce these costs by $200. Row 1300C, shows that reducing the temperature in zone 2 (which may be larger than zone 1) during the month of January by 1° F. will reduce heating costs by $200 for the month.

It will be appreciated that the report 1300 is merely illustrative. In accordance with the principles of the invention, many different reports can be generated, including ones containing different information in different formats, as selected by a user.

In operation, a system models environmental characteristics of zones in buildings, such as by using Equations 1-11 above or similar equations. In one embodiment, the modeling is performed using a single power meter. During the modeling process, HVAC components are exercised using an abstraction language that hides the component-specific workings as well a command prerequisites from the programmers, allowing the testing software to be both compact and portable. The process includes inserting software agents into the normal operating software for the components. Advantageously, the agents monitor the connection between the components and modeling platform. If the connection is broken, the inputs to the components are rolled back, to their pre-testing configurations. Using these models, the HVAC components can be adaptively managed and reports about component efficiency can be generated and environment settings set to reduce costs.

While the description above gives examples of HVAC components that can be modeled in accordance with the principles of the invention, it will be appreciated that any type of electro-mechanical component is able to be modeled, including, but not limited to, other HVAC components such as sensors (e.g., temperature, flow, pressure, humidity, etc), actuators, variable speed drives for motor speed control (also called variable frequency drives), fans, dampers, air-side economizers, pumps, valves, reheat valves, pre-heat valves, heating valves, chilled water valves, automatic isolation valves, automatic shut-off valves, chillers, air-cooled chillers, water-cooled chillers, cooling towers, fluid coolers, dry coolers, water-side economizers, hot-water boilers, steam boilers, furnaces, humidifiers, desiccant dehumidifiers, evaporative coolers, direct evaporative coolers, indirect evaporative coolers, heating coils, cooling coils, pre-heat coils, air-to-water heat exchangers, water-to-water heat exchangers, radiant heating equipment, radiant cooling equipment, underfloor air-distribution equipment, baseboard heaters (convectors) baseboard radiators, unitary air-conditioning equipment (packaged units), heat pumps, air-source heat pumps, water-source heat pumps, ground-source heat pumps, water-cooled AC units, self-contained water-cooled DX units, variable air volume (VAV) cooling-only terminal units, variable air volume (VAV) reheat terminal units (with either electric heat or hot-water heating coil), dual-duct variable air volume (DDVAV) terminal units, fan-powered VAV terminal units, series fan-powered VAV terminal units (with and without heating coil) for electric or hot-water heating, and parallel fan-powered VAV terminal units (with and without heating coil) for electric or hot-water heating.

While many of the examples above describe HVAC systems, it will be appreciated that the principles of the invention are able to be used in other systems. For example, many other building components can be auto commissioned in accordance with principles of the invention, including, not only HVAC components and their control systems, but also plumbing components, electrical systems, first and life safety systems, building envelopes, co-generation units, utility plants, sustainable systems, lighting components, wastewater units, control units, and building security units, to name only a few examples.

It will be readily apparent to one skilled in the art that various other modifications may be made to the embodiments without departing from the spirit and scope of the invention as defined by the appended claims.

We claim:

1. A method of modeling performance of an electro-mechanical component that controls an environment within one of multiple zones in a building, the method comprising:
varying an input to the electro-mechanical component to generate associated outputs from the electro-mechanical component; and
generating a performance model of the electro-mechanical component based on the input, the associated outputs, and an energy consumption of the electro-mechanical component.

2. The method of claim 1, wherein the energy consumption of the electro-mechanical component is determined from an energy consumption for the building while varying the input.

3. The method of claim 2, further comprising measuring the energy consumption for the building while varying the input.

4. The method of claim 1, wherein the performance model characterizes power consumed by the electro-mechanical component as a function of at least one of temperature and air flow rate.

5. The method of claim 1, wherein the multiple electro-mechanical components comprise a fan, a chiller, a reheat valve, a packaged air-conditioning unit, or any combination thereof.

6. The method of claim 1, wherein the electro-mechanical component is one of multiple electro-mechanical components within the multiple zones in the building, the method further comprising:
while varying the input to the electro-mechanical component, maintaining outputs of remaining ones of the multiple electro-mechanical components at a preselected condition.

7. The method of claim 6, wherein the preselected condition corresponds to a low-power state of the remaining ones of the electro-mechanical components.

8. The method of claim 1, wherein the energy consumption comprises electrical consumption, gas consumption, or both.

9. The method of claim 5, wherein the associated outputs correspond to air flows, air temperatures, rates of increase of air temperature, rates of increase of air flow, or any combination thereof.

10. The method of claim 1, wherein the performance model comprises a nonlinear partial differential equation or an autoregression-moving-average model.

11. The method of claim 10, wherein the nonlinear partial differential equation comprises a Navier-Stokes equation.

12. The method of claim 1, wherein the performance model is generated from constrained least square, unconstrained least square, linear optimization, nonlinear optimization, Kalman filtering, or any combination thereof.

13. The method of claim 1, further comprising:
receiving commands from a controller for varying the inputs; and
restoring a prior input to the electro-mechanical component when communication between the controller and electro-mechanical component is interrupted.

14. The method of claim 13, further comprising using a heartbeat initiated by the controller to detect that communication between the controller and the electro-mechanical component is interrupted.

15. The method of claim 13, wherein the commands are in an abstraction language.

16. The method of claim 13, wherein the commands comprise checking whether operating conditions are met before varying the inputs.

17. The method of claim 16, wherein the operating conditions comprise determining that a damper is open before increasing a pressure with a duct.

18. The method of claim 13, wherein the controller and the electro-mechanical component are communicatively coupled over the Internet.

19. The method of claim 1, further comprising:
determining performance models for each of the multiple electro-mechanical components within corresponding ones of the multiple zones, thereby generating multiple performance models; and
combining the multiple performance models to generate a performance model for the building.

20. The method of claim 1, further comprising generating a report summarizing energy savings or cost savings for any one or more of the multiple electro-mechanical components based on selected environmental settings.

21. The method of claim 1, wherein the outputs correspond to steady-state performance, dynamic performance, or both.

22. The method of claim 1, further comprising using the performance model for model-based control, fault detection, system design, automatic PID gains tuning, or any combination thereof.

23. The method of claim 1, wherein the multiple zones comprise physically partitioned areas.

24. A method of characterizing performance of a building component comprising:
choosing a set of inputs and one output for the building component;
selecting a set of steady-state operation points for each input and a duration at each of the stead-state operation points; and
characterizing a performance of the component based on a log of the steady-state operation, historical performance data and data sheets for the component.

25. A method of adaptively updating a performance model for a heating, ventilation, and air-conditioning (HVAC) unit, the method comprising:
determining a model characterizing performance of an HVAC unit;
automatically, periodically driving the HVAC unit with inputs and measuring associated outputs from the HVAC unit; and
using the inputs and associated outputs to update the performance model.

26. The method of claim 25, wherein determining the model characterizing the performance of the HVAC unit is based on historical performance data for the HVAC unit.

27. The method of claim 25, wherein the HVAC unit is driven with inputs using commands in an abstraction language.

28. The method of claim 27, wherein the abstraction language translates a source command to drive the HVAC unit from a format not supported by the HVAC unit into one or more target commands in a format that is supported by the HVAC unit.

29. The method of claim 25, further comprising:
logically inserting an agent, comprising computer-executable instructions for step-testing the HVAC unit, within normal-operating computer-executable instructions for controlling the HVAC unit.

30. The method of claim 29, wherein the agent comprises a heart-beat monitor, for monitoring a connection between the HVAC unit and a platform.

31. A method of adaptively managing a performance model for a heating, ventilation, and air-conditioning (HVAC) component, comprising:
a. generating a descriptive model of the HVAC component;
b. generating an abstract of data and control mapping for the HVAC component;
c. calculating parameters for the model;
d. optimizing performance for the model based on pre-determined criteria;
e. simulating the optimization;
f. applying the optimization to the model;
g. repeating steps a through f until a measured system state matches an expected system state.

32. The method of claim 31, wherein the HVAC component comprises a fan, a chiller, a reheat valve, a packaged air-conditioning unit, or any combination thereof.

33. An electro-mechanical component for controlling an environment within a zone in a building comprising:
a thermal element for controlling a thermal environment in the zone;
a sensor for measuring a characteristic of the thermal environment in the zone; and
a controller that varies an input to the mechanical component to generate a corresponding output of the thermal element within the zone and generates a performance model for the electro-mechanical component based on energy consumption of the building, the input, and the output.

34. The electro-mechanical component of claim 33, wherein the controller comprises:
a processor; and
a computer-readable medium containing computer-executable instructions that when executed by the processor varies an input to the mechanical component to generate a corresponding output of the thermal element within the zone and generates a performance model for the electro-mechanical component based on the input, the output, and an energy consumption of the building.

35. The electro-mechanical component of claim 33, wherein the electro-mechanical component forms part of a fan, a chiller, a reheat valve, a packaged air-conditioning unit, or any combination thereof.
